(19) United States
(12) Patent Application Publication
(10) Pub. No.: US 2013/0335193 A1
(43) Pub. Date: Dec. 19, 2013

(54) ELECTRONIC WIRELESS LOCK

(71) Applicant: 1556053 ALBERTA Ltd., Calgary (CA)

(72) Inventors: Paul Hanson, Calgary (CA); Geoffrey Kratz, Calgary (CA); Curtis Bennett, Calgary (CA)

(73) Assignee: 1556053 ALBERTA LTD., Calgary (CA)

(21) Appl. No.: 13/688,037

(22) Filed: Nov. 28, 2012

Related U.S. Application Data
(60) Provisional application No. 61/564,735, filed on Nov. 29, 2011.

(51) Int. Cl. G07C 9/00

(52) U.S. Cl. CPC G07C 9/00174
USPC 340/5.61

(57) ABSTRACT

An electronic lock device may grant a wireless-communication device permission to join a secure wireless connection with the electronic lock via a local wireless-communication network. If the wireless-communication device includes an electronic lock management application, the electronic lock device may switch the state of the lock mechanism to the unlocked state in response to joining the secure wireless connection with the first wireless-communication device and receiving a valid security code from the electronic lock management application. If the first wireless-communication device does not include the electronic lock management application, the electronic lock device may automatically switch the state of the lock mechanism to the unlocked state in response to joining the secure wireless connection with the first wireless-communication device.

### CROSS REFERENCE TO RELATED APPLICATIONS

This application claims priority to U.S. Provisional Patent Application No. 61/564,735, filed Nov. 29, 2011, and entitled ELECTRONIC WIRELESS LOCK, the entirety of which is hereby incorporated herein by reference.

### BACKGROUND

Traditionally, a lock for securing a piece of property may be unlocked by a key or through entering a combination. An individual may have a number of different locks to secure various pieces of property, such as a house lock, a bicycle lock, a mail box lock, a gym locker lock, etc. Each lock may require a different key or a different combination to unlock that lock. When considering all of the locks that an individual may have, it may be cumbersome to carry a number of different keys or to remember a number of different combinations in order to unlock all of the different locks.

### SUMMARY

Embodiments are disclosed that relate to an electronic lock device and controlling an electronic lock device via communication through a local wireless-communication network. For example, in one embodiment, an electronic lock device may grant a wireless-communication device permission to join a secure wireless connection with the electronic lock via a local wireless-communication network. The electronic lock device may automatically switch a state of a lock mechanism to an unlocked state in response to joining the secure wireless connection with the wireless-communication device.

### BRIEF DESCRIPTION OF THE DRAWINGS

FIG. 1 shows an electronic lock device that is controlled by a wireless-communication device according to an embodiment of the present disclosure.

FIG. 2 shows an electronic lock device that is controlled by a wireless-communication device according to another embodiment of the present disclosure.

FIG. 3 shows an example of an electronic lock device that is paired with and can be opened by each of a plurality of wireless-communication devices.

FIG. 4 shows an example of a wireless-communication device that is paired with and can open each of a plurality of electronic lock devices.

FIG. 5 shows an electronic lock system according to an embodiment of the present disclosure.

FIG. 6 shows an electronic lock device according to an embodiment of the present disclosure.

FIG. 7 shows an electronic lock management application according to an embodiment of the present disclosure.

FIG. 8 shows a method that may be performed by an electronic lock device for establishing a secure wireless connection with a wireless-communication device according to an embodiment of the present disclosure.

FIG. 9 shows a method that may be performed by an electronic lock device for establishing a secure wireless connection with a wireless-communication device that may execute an electronic lock management application according to an embodiment of the present disclosure.

FIG. 10 shows a method that may be performed by an electronic lock management application of a wireless-communication device for controlling an electronic lock device according to an embodiment of the present disclosure.

FIG. 11 shows a method that may be performed by an electronic lock management application of a wireless-communication device for establishing a secure wireless connection with an electronic lock device in an electronic lock system according to an embodiment of the present disclosure.

FIG. 12 shows a method that may be performed by an electronic lock management service computer for validating a wireless-communication device to control an electronic lock device according to an embodiment of the present disclosure.

### DETAILED DESCRIPTION

The present description relates to an electronic lock device that is configured to be controlled by a wireless-communication device. As one nonlimiting example, a Bluetooth®-communication device, such as a mobile phone, acts as a “key” to open the electronic lock device. Such a Bluetooth®-communication device may establish a secure relationship with the electronic lock device that permits the Bluetooth®-communication device to change the state of the electronic lock from a locked state to an unlocked state. By incorporating such functionality into an electronic lock device, users can unlock the electronic lock device via a wireless-communication device without needing to carry a physical key or having to remember a combination in order to open the electronic lock device.

It will be appreciated that the Bluetooth® communication technology standard is only one possible communication standard for implementing the wireless electronic lock concepts discussed herein. However, it is to be understood that local wireless communication may be performed according to other technology standards (e.g., Near Field communication, ZigBee®, etc.) without departing from the scope of the present disclosure. While embodiments that use Bluetooth® technology are discussed below, it is to be understood that any other suitable wireless technology may be used without departing from the scope of this disclosure.

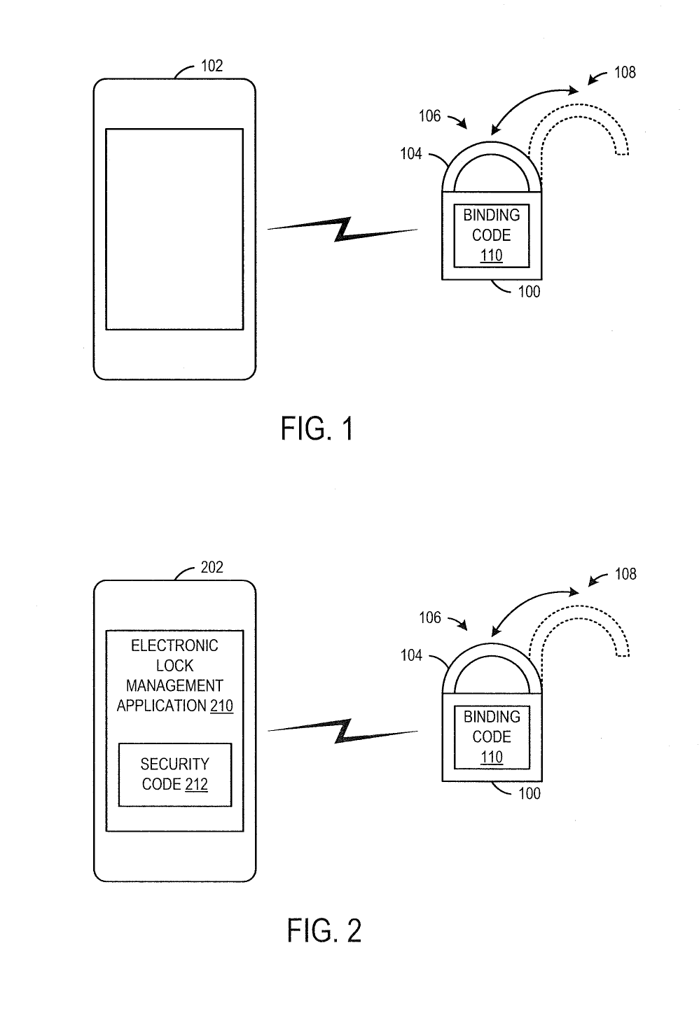

FIG. 1 schematically shows an embodiment of a standalone electronic lock device 100 that is controlled by a Bluetooth®-communication device 102. The electronic lock device 100 includes a lock mechanism 104 configured to switch or toggle between a locked state 106 and an unlocked state 108. The lock mechanism 104 may take the form of any suitable mechanism for locking or securing an object without departing from the scope of the present disclosure. For example, the lock mechanism 104 may include a padlock, deadbolt, etc.

The Bluetooth®-communication device 102 may be any suitable type of device capable of performing Bluetooth® communication with the electronic lock device 100. Non-limiting examples of a Bluetooth®-communication device include a mobile phone, personal digital assistant, tablet computing device, wireless-communication fob, etc.

The Bluetooth®-communication device 102, or other suitable wireless-communication device, may be configured to establish a secure wireless connection with the electronic lock device 100. In particular, the secure wireless connection may be established by validating a binding code 110 that is associated with the electronic lock device 100. For example, during the Bluetooth® pairing process, the Bluetooth®-communication device 102 may discover the electronic lock device 100 and vice versa, and the two devices may establish an encrypted radio channel. Using the interface of the Bluetooth®-communication device, the user may select the electronic lock device from a list of possible devices that the Bluetooth®-communication device has identified. Once the electronic lock device has been selected, the Bluetooth®-communication device 102 may prompt a user to enter a binding code 110 (e.g., Bluetooth® pairing code) that is associated with the electronic lock device 100. As an example, the pairing code may be associated with the electronic lock device during manufacture, and the pairing code may be printed and shipped with the electronic lock device. In one particular example, the pairing code is an eight-digit code. Once entered by the user, the Bluetooth®-communication device may send the pairing code to the electronic lock device via Bluetooth® communication. The electronic lock device may validate the pairing code by comparing the pairing code received from the Bluetooth®-communication device with the associated pairing code. If both paring codes are the same, then a secure relationship or trusted pair may be automatically formed that includes establishing unique or individualized credentials (e.g., in the form of a new code) that will be used for subsequent unlocking events, and the electronic lock device and the Bluetooth®-communication device may securely exchange data via Bluetooth® communication.

Note that the binding process may be performed when a user activates the electronic lock device (e.g., by pushing an activation button) with the wireless-communication device in a discoverable state and within local wireless-communication range of the electronic lock device.

It will be appreciated that any suitable secure wireless connection process may be performed between a wireless-communication device and an electronic lock device without departing from the scope of the present disclosure. For example, the secure wireless connection process may not conform to the pairing process of the Bluetooth® technology standard, and instead the electronic lock device may determine whether the wireless-communication device is valid in a different manner.

The binding code 110 may be a multi-digit code that is individualized for the electronic lock device 100. In particular, a binding code associated with one electronic lock device may be different from binding codes associated with other electronic lock devices. For example, if the binding code is an eight-digit code, then an individualized binding code value may be selected from 10⁸ possible different code values. In one example, an eight-digit binding code may be randomly selected and assigned to each electronic lock device. The individualized binding code may provide security for the electronic lock device, because the randomness and large number of possible values from which the individualized code is selected makes it difficult for an unwanted third-party to guess the code. Moreover, a different binding would have to be guessed for each electronic lock device.

The binding process may be an initial or one-time operation. For example, once binding has been established the binding code need not be used again to join a secure wireless connection unless the binding needs to be re-established. This could be to bind a different wireless-communication device to the electronic lock device, or if the secure credentials have been deleted from the wireless-communication device or the electronic lock device.

Once paired, the Bluetooth®-communication device 102 may securely connect with the electronic lock device 100 via Bluetooth® communication to change a state of the lock mechanism 104. In one example, the electronic lock device 100 may automatically switch from the locked state 106 to the unlocked state 108 in response to the electronic lock device being activated and in Bluetooth® communication range with the Bluetooth®-communication device 102 so that the Bluetooth®-communication device 102 may securely connect with the electronic lock device. This configuration may provide convenience to the user, because the user can unlock the electronic lock device without having to take out the wireless-communication device and enter input into the wireless-communication device. The distance at which the devices may communicate may be dictated or tuned according to a signal strength produced by antennas of the devices. It will be appreciated that the antennas may be designed or selected according to a desired communication distance. In general, the communication distance may be selected so that the electronic lock device only unlocks when a wireless-communication device is within a desired distance of the lock (e.g., one meter).

In some embodiments, the unlocked state may include the lock mechanism physically changing state. For example, a deadbolt may slide to an open position. In some embodiments, the unlocked state may include the lock mechanism electrically or magnetically changing state.

As introduced above, the electronic lock device 100 may be a standalone lock device. In other words, the electronic lock device 100 does not require access to a broader communication network (e.g., a WIFI wireless network or a cellular network) to function. Instead, wireless communication occurs on a local (or personal) basis between the electronic lock device 100 and the Bluetooth®-communication device 102 via a Bluetooth® network.

Optionally or alternatively, in some embodiments, an electronic lock device may connect to a wireless network or a cellular network without departing from the scope of the present disclosure. For example, the electronic lock device may be configured to connect to a wireless computer network or a cellular network to call a designated phone number (e.g., 911 or a non-emergency response line) responsive to detection of tampering with the electronic lock device. In one particular example, the electronic lock device calls the phone number of a designated security firm and plays a computerized voice message that indicates the electronic lock device has been tampered with. In another example, the electronic wireless lock may report operating or history information to centralized service management service via a wireless computer network or a cellular network.

It will be appreciated that the secure wireless connection between the electronic lock device 100 and the Bluetooth®-communication device 102 may be established as a built-in or native function of the Bluetooth®-communication 102. In other words, the mobile phone 102 need not download and/or execute a specialized application in order to establish the secure wireless connection with the electronic lock device 100.

FIG. 2 schematically shows an embodiment of the electronic lock device 100 being controlled by a wireless-communication device 202 via an electronic lock management application 210. Components of FIG. 1 that may be substantially the same as those of FIG. 2 are identified in the same way and are described no further. However, it will be noted that components identified in the same way in different embodiments of the present disclosure may be at least partly different.

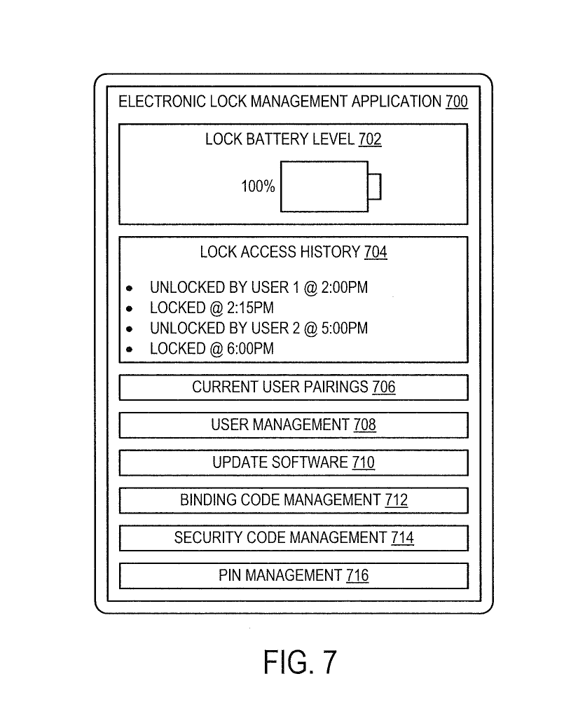

The electronic lock management application 210 may be executable by the wireless-communication device 202 to manage operation of the electronic lock device 100. The electronic lock management application 210 may provide additional functionality beyond the operation of the wireless-communication device by itself as shown in FIG. 1. For example, the electronic lock management application may be configured to interrogate the electronic lock device to receive operating information of the electronic lock device. Such information may be presented to the user on a display of the wireless-communication device by the electronic lock management application. Further, the electronic lock management application may be configured to allow a user to modify operation of the electronic lock device, such as managing security settings and constraints, managing user permissions, or the like which will be discussed in further detail below with reference to FIG. 7.

The electronic lock management application 210 may be configured to provide a secondary level of security beyond the secure wireless connection between the electronic lock device and the wireless-communication device shown in FIG. 1. For example, when the wireless-communication device 202 and the electronic lock device 100 are bound and securely connect for the first time, the electronic lock management application 210 may be identified as being present on the wireless-communication device 202. In particular, when the electronic lock device securely connects with a wireless-communication device, the electronic lock device sends an inquiry to the wireless-communication device to find out if there is an electronic lock management application present on the wireless-communication device. If the wireless-communication device notifies the electronic lock device that the electronic lock management application is present, then the electronic lock device sets up a secondary relationship with the electronic lock management application. Subsequently, each time the wireless-communication device 202 securely connects with the electronic lock device 100, the electronic lock management application 210 may send a security code 212 to the electronic lock device. If the electronic lock device validates the security code, then the electronic lock device unlocks the lock mechanism 104. In other words, in this embodiment, the electronic lock device requires a secure wireless connection and validation of a security code in order to unlock the lock mechanism 104.

Note that the electronic lock device may inquire about the presence of an electronic lock management application upon every connection with a wireless-communication device that has not previously established a secure relationship with an electronic lock management application. Accordingly, wireless-communication devices that do not have a management application may not respond to the inquiry during each secure connection.

It will be appreciated that the security code 212 may take any suitable form without departing from the scope of the present disclosure. For example, the security code may include a security token or another form of multifactor authentication. As another example, the security code may be a rolling code that differs each time the wireless-communication device 202 connects with the electronic lock device 100. For example, the electronic lock device 100 and the electronic lock management application 210 may each store the same sequence of different security codes. When the electronic lock management application 210 initially communicates with the electronic lock device 100, the electronic lock management application may send a pointer to a particular security code in the sequence. During each subsequent connection, the devices may incrementally roll through the sequence from the pointer using a different security code in the sequence with each communication event. The rolling code may provide additional security since the code changes between connection events. For example, even if a particular rolling code is recorded by an uninvited third party during a communication event, the particular rolling code will not be valid during the next communication event because the rolling code changes.

Additionally or alternatively, the electronic lock management application 210 may be configured to require a personal identification number (PIN) to be entered by a user in order to initiate communication with the electronic lock device 100. For example, each time a user wants to unlock the lock mechanism of the electronic lock device, the user may be prompted to enter a PIN. The PIN may differ from the security code 210 in that the PIN may be actively entered by the user whereas the security code may be sent to the electronic lock device without any action by the user other than being in range for Bluetooth® communication.

In some embodiments, once securely paired, the electronic lock device 100 and the wireless-communication device 202 may exchange data in the form of operating information. For example, the electronic lock device 100 may report to the electronic lock management application 210 of the wireless-communication device 102 that the lock mechanism 104 has been successfully changed from the unlocked state 108 to the locked state 106 (e.g., even when the wireless-communication device 102 did not cause that state change, such as a user manually locking the lock mechanism).

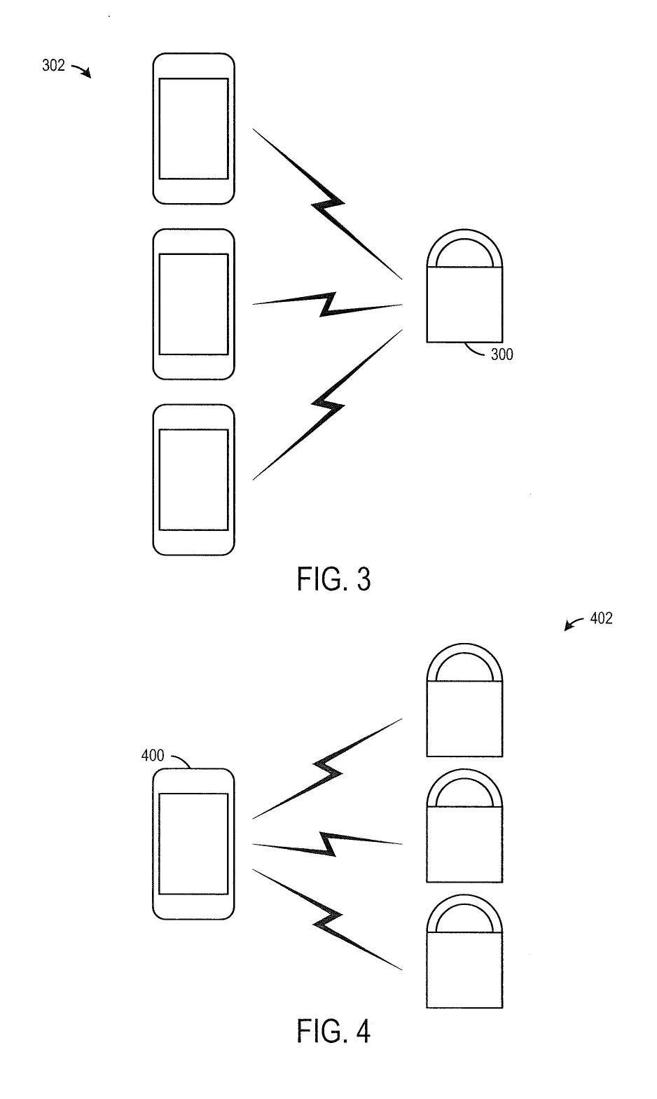

In some embodiments, an electronic lock device may support binding with a plurality of different wireless-communication devices. FIG. 3 shows an example of an electronic lock device 300 that is bound with, and can be unlocked by, each of a plurality of wireless-communication devices 302. In particular, each of the plurality of wireless-communication devices 302 may establish a secure wireless connection with the electronic lock device 300 to unlock the lock mechanism of the electronic lock device. In other words, each of the wireless-communication devices may act as a “duplicate key” that allows for more than one person to open the electronic lock device 300. In some embodiments, each of the plurality of wireless-communication devices 302 may be bound with the electronic lock device 300 via the same binding code. In some embodiments, each of the plurality of wireless-communication devices 302 may be bound with the electronic lock device 300 via a different binding code. In some cases, each binding code may be uniquely associated with a particular wireless-communication device and a particular electronic lock device. It will be appreciated that the electronic lock device may be bound with any wireless-communication device via any suitable binding process without departing from the scope of the present disclosure.

In some embodiments, the electronic lock device 300 may establish a secure wireless connection with different wireless-communication devices using different levels of security. For example, the electronic lock device 300 may join a secure wireless connection with a first wireless-communication device after being bound with the first wireless-communication device via validation of a binding code as described above with reference to FIG. 1. Further, the electronic lock device 300 may join a secure wireless connection with a second wireless-communication device that has an electronic lock management application, and the electronic lock device may validate a security code received from the electronic lock management application during each connection event as described above with reference to FIG. 2.

In some embodiments, a wireless-communication device may be bound with a plurality of different electronic lock devices to control (e.g., unlock) the different electronic lock devices. FIG. 4 shows an example of a wireless-communication device 400 that has joined a secure wireless connection with, and can unlock each of a plurality of electronic lock devices 402. In one particular example, the wireless-communication device 400 may undergo a separate binding process with each of the plurality of electronic lock devices 402 so that the wireless-communication device 400 may be validated by each of the plurality of electronic lock devices 402. In each binding process, the wireless-communication device 400 may use a different binding code that is associated with a different electronic lock device of each of the plurality of electronic lock devices 402. In other words, the different binding codes may act as different “keys” that a user collects in the wireless-communication device 400 to unlock different locks. It will be appreciated that a wireless-communication device may establish a secure wireless connection with, and control operation of any suitable number of different electronic lock devices without departing from the scope of the present disclosure. Moreover, in some embodiments, different wireless-communication devices may be bound with a different number of electronic lock devices or may have different permission levels to unlock different electronic lock devices.

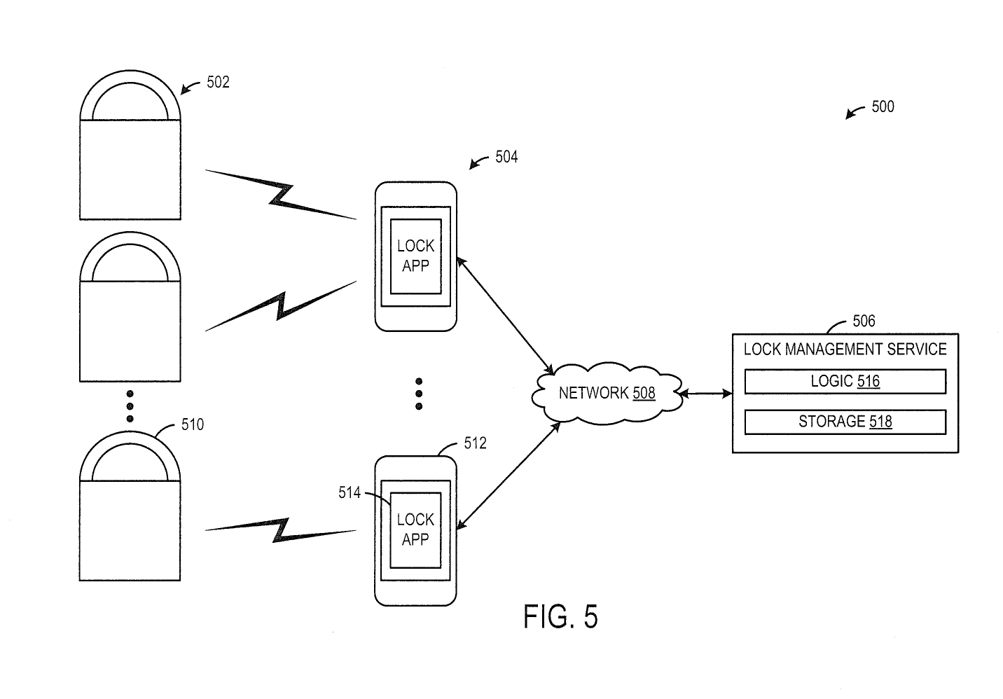

In some embodiments, the wireless-communication device 400 may be bound with different electronic lock devices operating in different modes. For example, the wireless-communication device 400 may join a secure wireless connection with a first electronic lock device that operates in a standalone mode as described above with reference to FIG. 1. The wireless-communication device 400 may execute an electronic lock management application that may be validated by the first electronic lock device as described above with reference to FIG. 2 to control operation of the first electronic lock device. Further, the wireless-communication device 400 may securely connect with and be validated by second and third electronic lock devices that operate in a system mode where validation is managed by a centralized electronic lock management service that may issue a security code to the wireless-communication device 400 responsive to validation. The system mode will be discussed herein with reference to FIG. 5.

FIG. 5 shows an example embodiment of an electronic lock system 500. The electronic lock system 500 includes a plurality of electronic lock devices 502 and a plurality of wireless-communication devices 504 that may be used to unlock the plurality of lock devices 502 via wireless communication (e.g., Bluetooth®). A centralized electronic lock management service computer 506 may be configured to manage operation of the plurality of electronic lock devices 502 and/or the plurality of Bluetooth®-communication devices 504. Each of the plurality of Bluetooth®-communication devices 504 include an electronic lock management application 514 that is configured to communicate with any of the plurality of electronic lock devices 502 once the wireless-communication device has joined secure wireless communication with that electronic lock device. The electronic lock management application 514 is further configured to communicate with the centralized electronic lock management service computer 506 via a computer network 508 to be granted permission to control a electronic lock device.

In the electronic lock system 500, the centralized electronic lock management service computer 506 may be configured to provide a security code to a wireless-communication device to control an electronic lock device based on validation of that wireless-communication device. In other words, the centralized electronic lock management service computer 506 may be configured to determine whether the wireless-communication device is authorized to control a particular electronic lock device within the electronic lock system. If a wireless-communication device is validated by the centralized electronic lock management service computer 506, then the centralized electronic lock management service computer 506 may send a security code to the wireless-communication device that may further be validated by the electronic lock device to grant permission to the wireless-communication device to control operation of the electronic lock device.

In one example interaction, a wireless-communication device and an electronic lock device may join a secure wireless connection. For example, a “Just Works” Bluetooth® pairing mechanism may be implemented during operation in system mode. Note this is merely one example, and other variations are possible.

Once the devices are securely connected, the electronic lock device may determine whether the wireless-communication device has an electronic lock management application and whether that application is associated with the enterprise or system of the electronic lock device. If the electronic lock management application and the electronic lock device are associated with the same enterprise or system, then the electronic lock device may send an identity of the electronic lock device to the electronic lock management application.

Further, the electronic lock management application may send the identity of the electronic lock device and the identity of the wireless-communication device to the centralized electronic lock management service computer via the computer network. The centralized electronic lock management service computer may determine whether the wireless-communication device is permitted to unlock the electronic lock device based on preset permissions or constraints established by the centralized electronic lock management service computer. If the centralized electronic lock management service computer determines that the wireless-communication device meets the preset constraints or permissions, then the centralized electronic lock management service computer sends a security code associated with the electronic lock device to the electronic lock management application of the wireless-communication device via the computer network. The electronic lock management application may send the security code to the electronic lock device via Bluetooth® communication. The security code may be included in a request to unlock a lock mechanism of the electronic lock device. The electronic lock device may validate the security code and unlock the lock mechanism responsive to validation of the security code.

In some embodiments, an electronic lock device may be configured to switch between operation in a standalone mode or a system mode. For example, all electronic lock devices may be sold in standalone mode, and a system administrator may perform an operation to change the mode of the electronic lock device to operate in system mode. In one example, the switch between standalone mode and system mode may be performed by actuating a mechanical switch on the electronic lock device.

In another example, the switch between standalone mode and system mode may be performed by a system administrator via the electronic lock management application on a Bluetooth®-communication device. For example, setting an electronic lock device to operate in system mode may include executing the electronic lock management application on the mobile phone, waking up the electronic lock device to activate Bluetooth® communication, and setting a pairing code to “0000” instead of a unique or individualized binding/pairing code used in standalone mode on the mobile phone. Once the electronic lock device receives the “0000” code, the electronic lock device enters system mode and exchanges association information with the centralized electronic lock management service computer via the electronic lock management application.

Note that the switch to system mode may be prevented if the electronic lock has already joined a secure wireless connection with another wireless-communication device, as a measure to avoid an unwanted third party from controlling the electronic lock device.

In some embodiments, the centralized electronic lock management service computer 506 may be configured to provide various administrator tools. For example, the centralized electronic lock management service computer may be configured to maintain lists or databases indicating which wireless-communication device/users are allowed to access which electronic lock devices, including controlling when they can access an electronic lock device based on different constraints that may be established by a system administrator. For example, a constraint may include allowing a user to only control a particular electronic lock device between 9:00 AM and 5:00 PM Mountain Time on weekdays. In another example, a constraint may allow a user to only control an electronic lock device up to and including a particular date but not after that date.

Furthermore, the centralized electronic lock management service computer 506 may be configured to revoke access rights to one or more electronic lock devices for a particular user. The centralized electronic lock management service computer 506 may be configured to add, delete, or modify permissions or access rights for users of different electronic lock devices. The centralized electronic lock management service computer 506 may be configured to determine whether a user can only unlock an electronic lock device, or also have access to the electronic lock device operating information for log retrieval, operating information inquiry, etc. The centralized electronic lock management service computer 506 may be configured to track where, physically, an electronic lock device is expected to be, for electronic lock devices that are associated with a fixed location.

The centralized electronic lock management service computer 506 may include any suitable computing device and/or service-oriented software architecture executed by a computing device. For example, the centralized electronic lock management service computer 506 may include a logic machine 516 and a storage machine 518. The logic machine includes one or more physical devices (e.g., processors) configured to execute instructions. Additionally or alternatively, the logic machine may include one or more hardware or firmware logic machines configured to execute hardware or firmware instructions. The storage machine 518 includes one or more physical devices configured to hold instructions executable by the logic machine to implement the methods and processes described herein.

Aspects of the logic machine 516 and the storage machine 518 may be integrated together into one or more hardware-logic components. Such hardware-logic components may include application-specific integrated circuits or system-on-a-chip (SOC), for example. Although referred to as a single computer, it will be appreciated that the centralized electronic lock management service computer may be implemented as a plurality of different computers (e.g., a server farm).

The centralized electronic lock management service computer 506 is accessible over any suitable transmission protocols (e.g., Internet) independent of platforms and programming languages via the computer network 508. In some embodiments, the centralized electronic lock device management service computer 506 may be hosted remotely from a location where the plurality of electronic lock devices 502 is located (e.g., administered by a third party). In such embodiments, the plurality of Bluetooth®-communication devices 504 may access the centralized electronic lock management service computer 506 using secure hypertext transfer protocol (HTTPS) or a similar mechanism. In some embodiments, the centralized electronic lock management service computer 506 may be hosted locally from a location where the plurality of electronic lock devices 502 is located (e.g., administered by a customer). In such embodiments, the plurality of Bluetooth®-communication devices 504 may access the centralized electronic lock management service via any suitable communication protocol. In one example, the plurality of Bluetooth®-communication devices access the centralized electronic lock management service computer using a secure HTTP interface via their Internet connection. As another example, the plurality of Bluetooth®-communication devices access the centralized electronic lock management service computer using an on-device virtual private network (VPN) connection.

The computer network 508 may include a cellular network, wireless local area network (WLAN), wide area network (WAN), or any other suitable type of wireless network without departing from the scope of the present disclosure. Note that the electronic lock device 510 need not communicate directly with the centralized electronic lock management service computer 506. Rather, the electronic lock device 510 may pass information to the centralized electronic lock management service computer 506 through the electronic lock management application 514 on the Bluetooth®-communication device 512. In this way, the electronic lock devices do not require a network connection or any associated subscription fees.

It will be appreciated that an electronic lock management application may be associated with a plurality of different enterprises or electronic lock systems. In particular, the electronic lock management application may be configured to communicate with centralized management services of the different electronic lock systems to retrieve security codes to control operation of different electronic lock devices associated with the different enterprises or electronic lock systems. In other words, a single electronic lock management application may be used to control operation of different electronic lock devices associated with different enterprises or electronic lock systems.

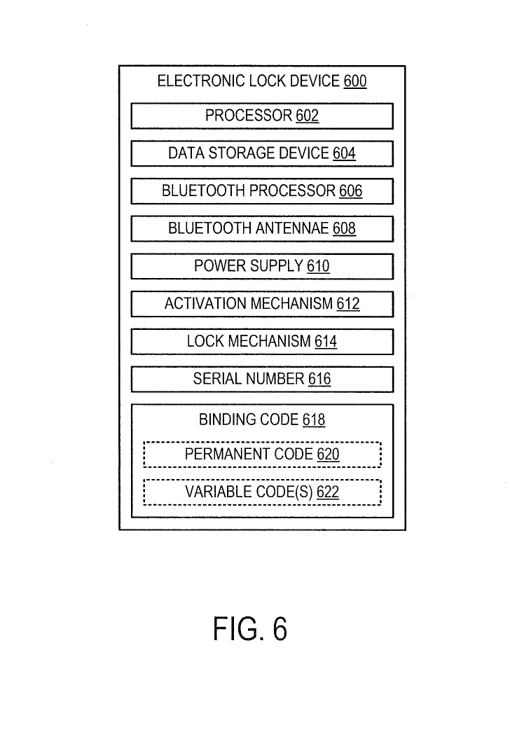

FIG. 6 schematically shows an example embodiment of an electronic lock device 600 of the present disclosure. The electronic lock device 600 includes a processor 602, a data storage device 604, a Bluetooth® processor 606, a Bluetooth® antennae 608, a power supply 610, an activation mechanism 612, a lock mechanism 614, a serial number 616, and a binding code 618.

The processor 602 includes one or more logic machines or physical devices configured to execute instructions stored in the data storage device 604. Such instructions may provide logic for validating binding codes or security codes to enable a Bluetooth®-communication device to unlock the electronic lock device. The logic further tracks operating information and generates access logs that identify which Bluetooth®-communication devices have unlocked or locked the electronic lock device 600, tracks when the electronic lock device 600 is unlocked or locked. The logic further manages user access through permissions and constraints.

The data storage device 604 may include one or more storage machines or physical devices configured to hold instructions executable by the processor 602 to implement the methods and processes described herein. When such methods and processes are implemented, the data storage device 604 may be transformed—e.g., to hold different data.

Aspects of the processor 602 and the data storage device 604 may be integrated together into one or more hardware-logic components. Such hardware-logic components may include application-specific integrated circuits or system-on-a-chip (SOC), for example.

The Bluetooth® processor 606 is configured to establish a secure wireless connection with a Bluetooth®-communication device upon validation of a binding code. In some embodiments, the Bluetooth® processor 606 and the processor 602 may be integrated into a single device (e.g., integrated circuit).

The Bluetooth® antennae 608 transmits data over short distances according to the Bluetooth® protocol to enable communication with a Bluetooth®-communication device that is in proximity to the electronic lock device 600.

The power supply 610 may include a battery, photovoltaic, external power source, piezoelectric, capacitor, and/or another suitable device to power the electronic lock device 600. In one example, the power supply 610 includes a photovoltaic source with a capacitor or re-chargeable battery to store energy. In another example, the power supply 610 includes a piezoelectric source with a capacitor to store energy. In yet another example, the power supply 610 includes a user-replaceable battery (e.g., AA or AAA batteries). The user-replaceable battery can be easily replaced when it runs down, and the electronic lock device can be used almost immediately. In yet another example, the power supply 610 includes a built-in battery that can be easily recharged. In yet another example, the power supply 610 includes a converter and plug that connects to an external power source, such as an outlet.

In some embodiments, the power supply 610 may be segregated so power from different sources is supplied to different components of the electronic lock device 600. For example, one power supply may provide power for Bluetooth® activation, and a separate power supply may provide power for the processor and data storage device.

Note in embodiments where the electronic lock device is configured to secure a laptop computer (or other electronic device), the electronic lock device may have access to a universal serial bus (USB) port of the laptop computer. In such embodiments, a USB cable may be connected between the laptop computer and the electronic lock device to draw power from the laptop computer to the electronic lock device. In some embodiments, the electronic lock device may include a rechargeable battery or a super capacitor that can hold enough power to open the electronic lock device even if the USB port is not powered when the laptop computer is shut down.

It will be appreciated that the electronic lock device 600 may remain locked if no power is present. Further, the electronic lock device 600 may continue to store security binding and other information when power is fully drained from the electronic lock device. In some embodiments, while in this state, the lock may not be able to be unlocked.

In some embodiments, to minimize power consumption the electronic lock device 600 may operate in a “sleep” mode to preserve power stored by the power supply 610. For example, during sleep mode, the electronic lock device 600 may deactivate Bluetooth® communication and other power consuming operations. Typical operation may include having the electronic lock device 600 fully sleep until activated, and consume minimal power for very short durations when the Bluetooth® antennae is active.

The activation mechanism 612 “wakes up” the electronic lock device 600 from sleep mode in order to enable Bluetooth® communication with a Bluetooth®-communication device. The activation mechanism 612 may wakeup the electronic lock device 600 in any suitable manner. In one example, the activation mechanism 612 includes a motion sensor, and activates responsive to detecting motion. In another example, the activation mechanism 612 includes a physical button or other actuator that is physically pressed by a user to activate the electronic lock device 600. In yet another example, the activation mechanism 612 includes a power generation device that is actuated by the user to provide power to “start up” the electronic lock device 600, such as a lever that is coupled to a piezoelectric device. It will be appreciated that the electronic lock device may be activated from sleep mode in any suitable manner without departing from the present disclosure.

The lock mechanism 614 toggles between an unlocked state and a locked state. The lock mechanism 614 may take the form of any suitable mechanism for locking or securing an object without departing from the scope of the present disclosure.

The serial number 616 may be used for establishing a secure wireless connection between the electronic lock device 600 and a Bluetooth®-communication device. In some embodiments, the serial number 616 may be physically located on the electronic lock device 600. For example, when the electronic lock device 600 operates in standalone mode, the serial number 616 may be examined by the user in order to correctly identify the electronic lock device 600. As another example, the serial number 616 may be associated with a multi-digit binding code that may be used to identify the electronic lock device 600 by a centralized electronic lock management service computer in a system implementation.

In some embodiments, the serial number may be omitted from the electronic lock device 600. For example, if the electronic lock device 600 is implemented in an electronic lock system and operates in a system mode, then an enterprise or electronic lock management service that is operating the electronic lock device may assign a unique identity that would be stored in the lock's permanent memory (e.g., data storage device 604) and managed by the electronic lock management service instead of a pre-assigned serial number.

The binding code 618 may be uniquely associated with the electronic lock device 600. The binding code 618 may be used to grant permission to a Bluetooth®-communication device to securely connect with the electronic lock device 600. For example, a user may enter the binding code 618 into the Bluetooth®-communication device. Further, the Bluetooth®-communication device may send the binding code 618 to the electronic lock device 600 along with identification data. The electronic lock device 600 may validate the binding code 618 to grant permission to the Bluetooth®-communication device to join a secure wireless connection with the electronic lock devices 600. Once the devices are bound, the electronic lock device 600 may automatically unlock the lock mechanism 614 whenever the Bluetooth®-communication device is securely connected to the electronic lock device 600. In one example, the binding code 618 corresponds to the binding code 110 of the electronic lock device 100 shown in FIG. 1. The binding code 618 may be stored in the data storage device 604.

In some embodiments, the binding code 618 may include a plurality of binding codes including a permanent binding code 620 and one or more variable binding codes 622. The permanent binding code 620 may be a binding code that cannot be changed or eliminated by a user of the electronic lock device 600. For example, the permanent binding code 620 may be assigned during manufacture of the electronic lock device 600. In some embodiments, the permanent binding code may be used in emergencies or as a backup in case a variable code is no longer available or does not function. In embodiments where the electronic lock device 600 is part of an electronic lock system, the permanent binding code may be used to control the electronic lock device when the electronic lock device has lost synchronization with a management service.

The variable binding code(s) 622 may be binding codes that can be modified by a user, such as by adding, deleting, or changing a variable binding code, a constraint associated with a binding code, or a permission associated with a binding code. In one example, a user may modify a variable binding code via an application (e.g., electronic lock management application 700 shown in FIG. 7).

In some cases, a variable binding code may be valid as long as a constraint is satisfied. Once the constraint is no longer satisfied, the secure wireless connection between the electronic lock device and the Bluetooth®-communication device may be abolished and/or the variable binding code may be automatically deleted from the electronic lock device.

Various non-limiting examples of variable binding codes with different constraints are discussed herein. In one example, a plurality of electronic lock devices each having a plurality of binding codes may be employed in a school to secure lockers of students. In this example, the permanent binding code may be the same for each of the plurality of electronic devices. The permanent binding code may be used as a master binding code that is known and used by a school administrator to control each electronic lock device. Further, a variable binding code of each electronic lock device may be revealed to a corresponding student, so that the student can use the variable binding code to control a corresponding electronic lock device. The variable binding code may be changed, or a new variable binding code may be added and the old variable code may be deleted by the administrator each time a different student is issued a locker. In one example, a variable binding code may have a constraint that specifies the variable binding code is only valid for the school year. After the school year is over, the variable binding code is no longer valid, because the constraint is not satisfied.

In another example, an electronic lock device may be incorporated into a commercial trailer that may be moved around to different terminals by different tractors provided by different trucking companies. The owner of the trailer (i.e., the shipper) may not know which specific individual will need to unlock the trailer. Further, the driver and the recipient of the shipment may not be associated with the shipper, and may not likely have a binding code or an electronic lock management application installed on their mobile device. As such, the electronic lock device may not operate in a system mode or according to other enterprise methods described herein. Rather, the electronic lock device may establish a secure wireless connection with a Bluetooth®-communication device of the shipper via a permanent binding code and may establish a secure wireless connection with a Bluetooth®-communication device of the recipient via a temporary variable binding code.

In this example, the shipper may associate a constraint with the variable binding code to limit control by the recipient. In particular, the variable binding code may be associated with a single wireless-communication device and limited to a finite number of unlock events. In other words, the variable binding code may be temporarily valid. For example, the constraint may be set such that the temporary binding code is valid for two unlock cycles: one for the driver to be able to unlock the trailer at a border crossing, and one for the recipient to unlock the trailer for unloading. After the second unlock event, the electronic lock device may determine that the variable binding code is no longer valid, and may abolish the secure wireless connection. Accordingly, the electronic lock device does not automatically unlock next time the Bluetooth®-communication device attempts to connect with the electronic lock device.

In another example, an electronic lock device may be used at a club or other entity with a number of different employees, members, and/or other people that are to be given at least some unlocking permissions. In such environments, a constraint may restrict a number of wireless-communication devices that can be bound with a designated binding code. For example, an owner of a club may use a permanent binding code, and employees of the club may use a designated variable binding code that has a constraint set to a threshold number of wireless-communication devices matching the number of employees of the club. Accordingly, if an employee of the club were to give the designated binding code to someone else, then the shared designated binding code would not be valid because the threshold number of devices would be exceeded.

It will be appreciated that the constraint may be set to any suitable threshold number of wireless-communication devices that can use a designated binding code to bind with an electronic lock device. Further, it will be appreciated that the constraint may be set to any suitable threshold number of unlock events.

In another example, a variable binding code may be associated with only a single Bluetooth®-communication device. Referring again to the shipper-driver example, the shipper may generate a variable binding code, and send it to the mobile phone of the driver. When the driver uses the variable binding code a first time with their mobile phone to establish the secure wireless connection with the electronic lock device, an association may be made between the variable binding code and the mobile phone that prevents the variable binding code from being used with any other device. In other words, a constraint associated with the variable binding code restricts the variable binding code to being valid for only one device. Accordingly, the variable binding code would not work with another device, for example if the driver shared the binding code with someone else. In this way, a likelihood of unauthorized use of an electronic lock device may be reduced.

In another example, a variable binding code may have an associated binding constraint that limits the variable binding code to a designated number of uses cumulatively by any number of different Bluetooth®-communication devices to unlock an electronic lock device. In particular, once the designated number of unlock events by Bluetooth®-communication devices that use the variable paring code occurs, the variable binding code is no longer valid, and the electronic lock device abolishes all of the secure wireless connections with Bluetooth®-communication devices that used the variable binding code. Further, the variable binding code may cease to work to establish a secure wireless connection between any Bluetooth®-communication device and the electronic lock device.

In another example, a variable binding code may have a constraint that is only satisfied when an electronic lock device is positioned at a designated location (e.g., geographic coordinates). Again referring to the shipping example, an electronic lock device may be used to lock the container or trailer. When the container or trailer arrives at the designated location that satisfies the constraint, the electronic lock device may be configured to identify the location as being the designated location associated with the variable binding code, and may activate or make functional the variable binding code. Accordingly, the electronic lock device may validate the variable binding code when received from a Bluetooth®-communication device, and may unlock the lock mechanism as long as the electronic lock device is positioned at the designated location. In this example, the variable binding code can be sent to the receiver of the container or trailer via an email, simple message service (SMS) message, shipping invoice, or electronic shipping manifest. This configuration may be preferred in transportation enterprises where the destinations are not part of the same organization and the receiver will not have access to a phone application to control the electronic lock device.

In another example, the variable binding code may be valid until the electronic lock device travels beyond a threshold distance from a particular geographic location. For example, a variable paring code may be valid until the electronic lock device travels one hundred meters from a parking spot (e.g., a distance to cross a storage yard). Once the electronic lock device travels beyond the threshold distance, the variable binding code is no longer valid. In some embodiments, the electronic lock device may be configured to automatically switch the lock mechanism to the locked state responsive to the variable binding code becoming invalid.

In some embodiments, the designated distance to enable the binding may be dynamically programmed into the electronic lock device, such as by an administrator. In some embodiments, the designated distance may be preconfigured in the electronic lock device prior to use. In some embodiments, the owner of the electronic lock device (e.g., the shipper in this example) may adjust the distance that satisfies the constraint.

In another example, a variable binding code may have a constraint where the binding code is valid for a designated time period. In some cases, the time period may be a single window of time during which the variable binding code may be valid, and at the end of the time period the variable binding code may no longer be valid and/or deleted. In some cases, the time period may be reoccurring, such as a repeated window of time. For example, the reoccurring time period may be set to every day from 8:00 AM to 5:00 PM. The variable binding code may be valid from 8:00 AM to 5:00 PM. Then the variable binding code may not be valid from 5:00 PM to 8:00 AM, and the secure wireless connection may be abolished. In this example, a Bluetooth®-communication device may re-establish the secure wireless connection with the electronic lock device each day.

It will be appreciated the electronic lock device and/or the electronic lock system may utilize any suitable algorithm or technique to generate a binding code without departing from the scope of the present disclosure.

In one example, the end user (e.g., the recipient of the shipment in this example) may be sent the variable binding code via email, text, obtained from a secure website, obtained from an electronic waybill sent separately from the shipment, or another suitable manner.

Note that when a binding code is associated with a constraint, the constraint may be applied to any secure relationship created using that binding code. In other words, the electronic lock device may apply the constraint to any wireless-communication device that enters a secure relationship using that binding code. Moreover, a wireless-communication device may have one or more additional constraints applied that are not associated with that binding code, but instead are associated with different binding codes or security codes.

In some applications where a variable binding code is utilized to temporarily permit a Bluetooth®-communication device to unlock an electronic lock device, an electronic lock management application need not be installed on the Bluetooth®-communication device in order to be temporarily bound. Further, the electronic lock device can be unlocked securely by different temporary users at different times with a unique or individualized temporary “key” each time.

In some embodiments, the electronic lock device may be employed in a setting where the Bluetooth®-communication device may be secured by the electronic lock device. For example, a mobile phone may be secured in a school or gym locker while a user is exercising or attending class. In such embodiments, the electronic lock device may include a removable electronic key fob/dongle. A user may remove the dongle from the electronic lock device when the user leaves the proximity of the electronic lock device, such as to attend class or exercise in the gym. The electronic lock device may be configured to remain in a particular state when the dongle is removed from the electronic lock device. For example, when the electronic lock device is locked and the dongle is removed, the electronic lock device will not unlock via communication with the mobile phone, it can only be opened by the dongle. In such embodiments, the electronic lock device may be aware of the state of the dongle relative to the electronic lock device (e.g., attached or removed). Additionally or alternatively, the mobile phone may be set to ignore access requests from the electronic lock device for a user-set number of minutes (e.g., enough time to take a shower at the gym).

FIG. 7 shows an example embodiment of an electronic lock management application 700 of the present disclosure. In one example, the electronic lock management application is executed by the Bluetooth®-communication device 202 shown in FIG. 2 in a standalone implementation. In another example, the electronic lock management application is executed by the Bluetooth®-communication device 512 shown in FIG. 5 in a system implementation. The electronic lock management application 700 enables a user to manage operation of one or more electronic lock devices including performing tasks and viewing operating information stored locally on the electronic lock device. The electronic lock management application 700 may be configured to retrieve operating information stored locally on an electronic lock device by communicating with the electronic lock device using transmission control protocol/internet protocol (TCP/IP) or some other protocol over Bluetooth® (e.g., RFCOMM protocol).

The electronic lock management application 700 includes a lock battery level indicator 702, a lock access history 704, a lock binding indicator 706, a user management interface 708, a software update interface 710, a binding code management interface 712, a security code management interface 714, and a PIN management interface 716.

The lock battery level indicator 702 displays the current power level of the battery in the electronic lock device. The lock access history 704 displays a list of devices that have unlocked (or locked) the electronic lock device, as well as the times when the electronic lock device was locked and unlocked. The lock binding indicator 706 displays a list of devices that currently are bound or have permission to unlock the electronic lock device. The user management interface 708 enables a user to associate a permission of a wireless-communication device with the electronic lock device or modify the list of devices that have permission to unlock the electronic lock device by adding or deleting devices from the list. The software update interface 710 provides an interface that allows a user to search for a most recent application software update, retrieve the application software update, and install the application software update on the device.

The binding code management interface 712 may permit a user to add, delete, or modify variable binding codes. Furthermore, the binding code management interface 712 may permit a user to associate various constraints with a variable binding code that affect the validity of the variable binding code. Further still, the binding code management interface 712 may permit a user to modify various constraints associated with a variable paring code.

The security code management interface 714 may permit a user to add, delete, or modify different security codes for different electronic lock devices. For example, different types of security codes include rolling codes, tokens, and other manners of authentication. The security codes may be passed between the electronic lock management application and the electronic lock device for validation during each unlock event. The security codes may provide an additional level of security beyond the binding codes.

The PIN management interface 714 permits a user to activate, deactivate, or modify a PIN that can be entered during each unlock event with an electronic lock device. The PIN provides an optional increase in a level of security beyond the paring code and the security code.

The electronic lock management application 700 may be executed by any suitable Bluetooth®-communication device, such as “smart phones.” However, it will be appreciated that any Bluetooth®-communication device may work as a key to unlock an electronic lock device with or without the wireless lock management application 700 by joining a secure wireless connection responsive to validation of binding code.

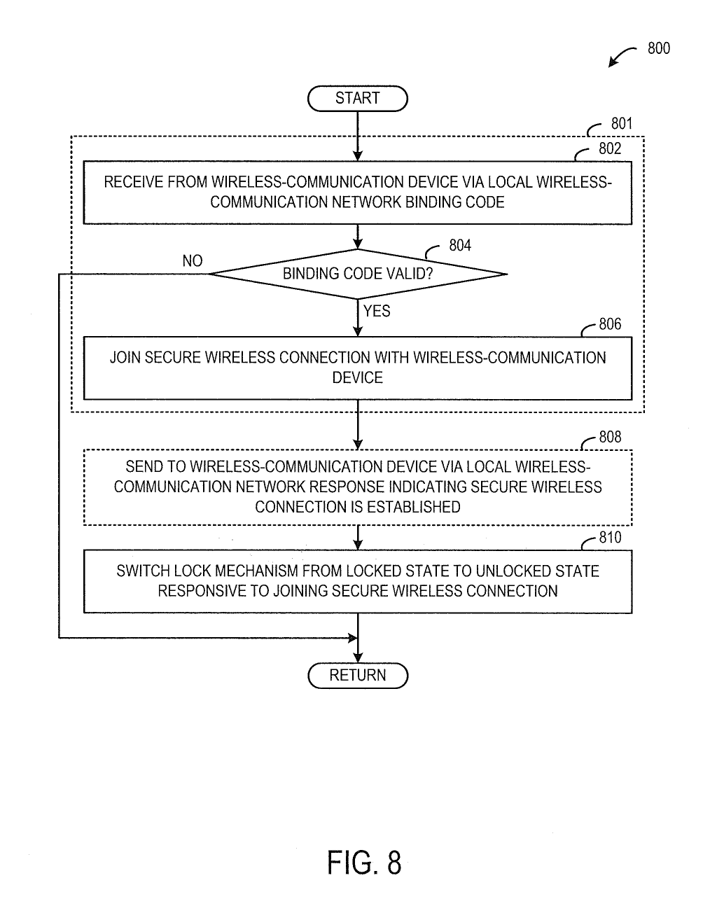

FIG. 8 shows a method 800 that may be performed by an electronic lock device for establishing a secure wireless connection with a wireless-communication device according to an embodiment of the present disclosure. For example, the method 800 may be performed by the electronic lock device 100 shown in FIG. 1. At 801, the method 800 may include granting a wireless-communication device permission to join a secure wireless connection with the electronic lock via a local wireless-communication network.

In one example, granting permission includes, at 802, receiving from the wireless-communication device via the local wireless-communication network a binding code. For example, the local wireless-communication network may be a Bluetooth® network, and the wireless-communication device may be a Bluetooth®-communication device. In a particular example, the wireless-communication device may be a Bluetooth®-enabled mobile phone.

At 804, the method 800 may include determining whether the binding code is valid. For example, the binding code may be validated by comparing the binding code with an associated binding code of the electronic lock device. In some embodiments, the binding code may be individualized or unique to the electronic lock device. If the binding code matches the associated binding code then the binding code may be determined to be valid.

In some embodiments, the binding code may further satisfy an associated constraint of the electronic lock device in order to be validated. For example, the associated constraint may include one or more of a number of unlock events initiated by the wireless-communication device being less than a threshold number of unlock events, a number of unlock events performed by the electronic lock device being less than a threshold number of unlock events, a number of wireless-communication devices currently bound with the electronic lock device being less than a threshold number of wireless-communication devices, a current time being within a designated time period, the electronic lock device being positioned within a threshold distance of a designated location, or another suitable constraint.

If it is determined that the binding code is valid, then the method 800 moves to 806. Otherwise, the method 800 returns to other operations.

At 806, the method 800 may include joining a secure wireless connection with the wireless-communication device. For example, joining a secure wireless connection may include storing an identity of the wireless-communication device in a list of devices that have permission to control operation of the electronic lock device. Accordingly, if the wireless-communication device subsequently connects with the electronic lock device, then the wireless-communication device may be automatically recognized without having to send the binding code to the electronic lock device.

Optionally, at 808, the method 800 may include sending to the wireless-communication device via the local wireless-communication network a response indicating that a secure wireless connection has been established and the wireless-communication device has been granted permission to control the electronic lock device.

At 810, the method 800 may include switching the lock mechanism from a locked state to an unlocked state. The switch may be performed responsive to joining the secure wireless connection with the wireless-communication device based on validation of the binding code.

The above method may enable an electronic lock device to join a secure wireless connection with a wireless-communication device via a local wireless-communication network, so that the wireless-communication device may control the electronic lock device.

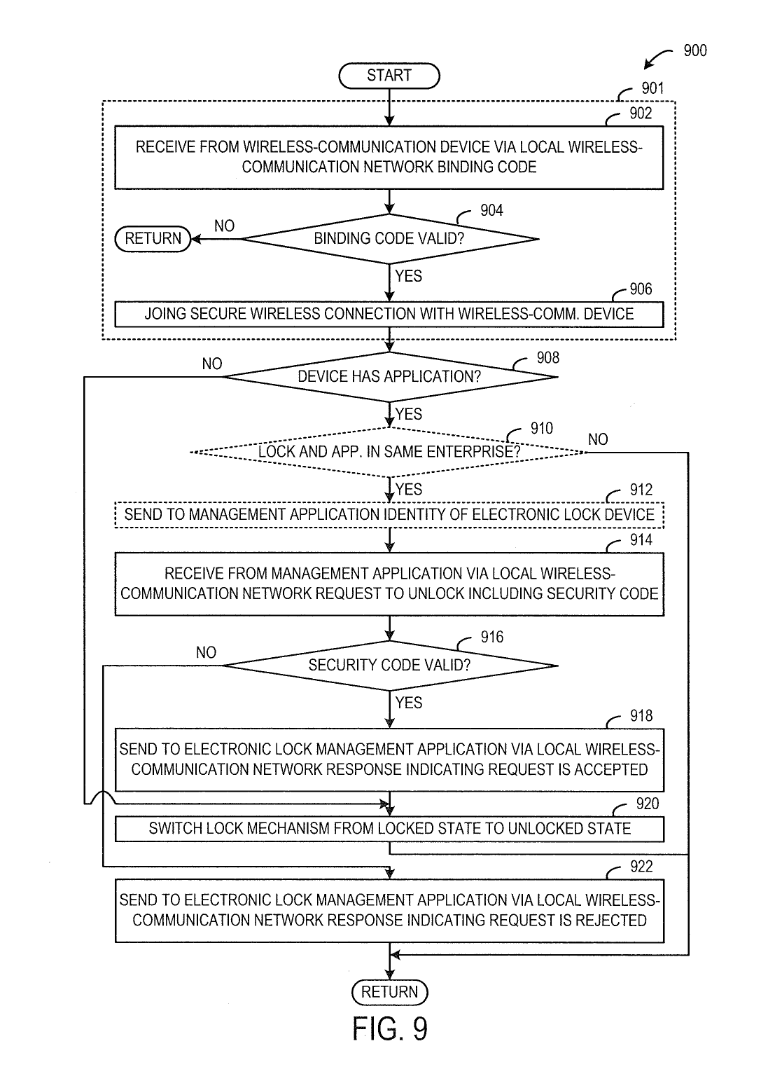

FIG. 9 shows a method that may be performed by an electronic lock device for establishing a secure wireless connection with a wireless-communication device that may execute an electronic lock management application according to an embodiment of the present disclosure. For example, the method 900 may be performed by the electronic lock device 100 shown in FIG. 2. At 901, the method 900 may include granting a wireless-communication device permission to join a secure wireless connection with the electronic lock via a local wireless-communication network.

In one example, granting permission includes, At 902, the method 900 may include receiving from a wireless-communication device via a local wireless-communication network a binding code.

At 904, the method 900 may include determining whether the binding code is valid. If it is determined that the binding code is valid, then the method 900 moves to 906. Otherwise, the method 900 returns to other operations.

At 906, the method 900 may include joining a secure wireless connection with the wireless-communication device.

At 908, the method 900 may include inquiring whether an electronic lock management application is present on the wireless-communication device. If an electronic lock management application is present on the device, then the electronic lock device enters into a secondary secure relationship with the electronic lock management application that requires validation of a security code to control operation of the electronic lock device, and the method moves to 910. Otherwise, the method 900 moves to 906.

In embodiments where the electronic lock device is included in an electronic lock system or associated with an enterprise, at 908, the method 900 may include determining whether the electronic lock management application present on the wireless-communication device is associated with the same enterprise or is included in the same electronic lock system as the electronic lock device. For example, the electronic lock device may send to the electronic lock management application via the local wireless-communication network an inquiry of an enterprise associated with the electronic lock management application. Further, the electronic lock device may receive a response from the electronic lock management application via the local wireless-communication network that includes the associated enterprise. If the electronic lock device and the wireless-communication device are associated with the same system or enterprise, then the method 900 moves to 910. Otherwise, the method 900 returns to other operations.

At 912, the method 900 may optionally include sending to the electronic lock management application via the local wireless-communication network an identity of the electronic lock device. For example, the identity may include a unique or individualized serial number or other suitable identifying information. The identity of the electronic lock device may be used by the wireless-communication device to retrieve a security code from a centralized electronic lock management service in order to unlock the electronic lock device.

At 914, the method 900 may include receiving from an electronic lock management application executed by the wireless-communication device via the local wireless-communication network a request to unlock the lock mechanism of the electronic lock device. The request may include a security code associated with the electronic lock device. For example, the security code may include a token, rolling code, or another form of authentication. As opposed to the binding code which is only used initially to establish a secure wireless connection, the security code may be received and validated each time a wireless-communication device connects to the electronic lock device.

At 916, the method 900 may include determining whether the security code is valid. For example, the security code may be validated by comparing the security code to a security code that is associated with the electronic lock device. If the security code is valid, then the method 900 moves to 918. Otherwise, the method 900 moves to 922.

At 918, the method 900 may include sending to the electronic lock management application via the local wireless-communication network a response indicating that the request to unlock the lock mechanism is accepted.

At 920, the method 900 may include switching the lock mechanism from a locked state to an unlocked state. In the case where the electronic lock management application is not present on the wireless-communication device, the lock mechanism may be unlocked responsive to the electronic lock device joining the secure wireless connection with the wireless-communication device. In the case where the electronic lock device is present on the wireless-communication device, the lock mechanism may be unlocked responsive to the electronic lock device joining the secure wireless connection with the wireless-communication device and validation of the security code.

At 922, the method 900 may include sending to the electronic lock management application via the local wireless-communication network a response indicating that the request to unlock the lock mechanism is rejected because the security code was not valid.

The method 900 may provide an additional level of security relative to the method 800, because the security code provided by the electronic lock management application may require validation during each unlock event.

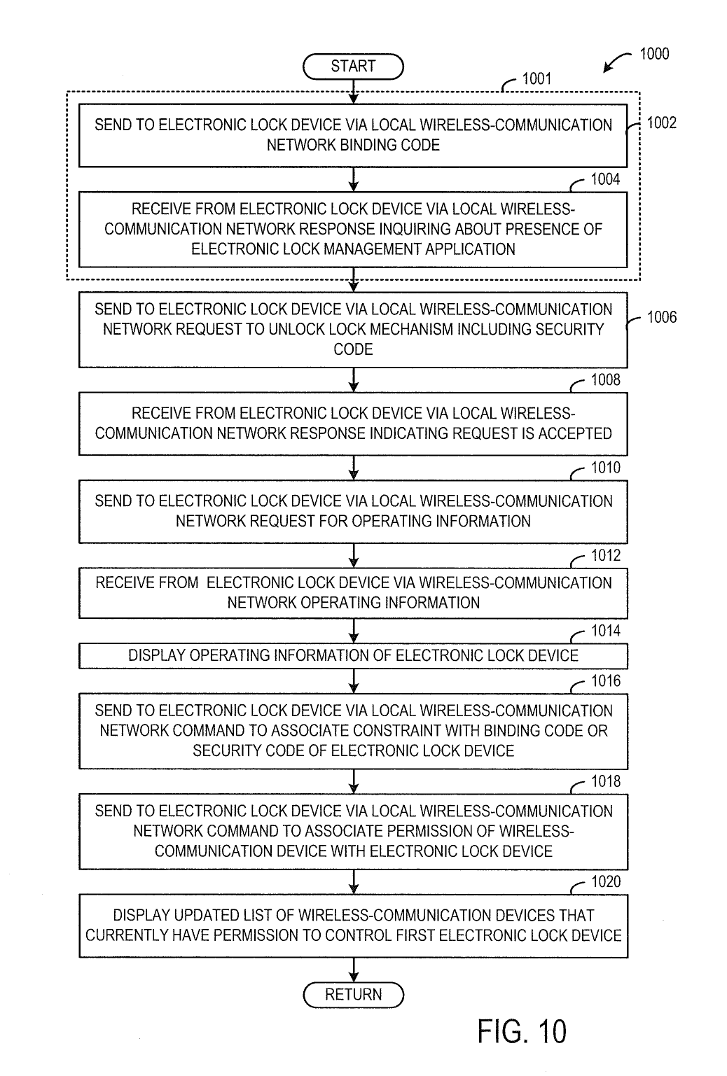

FIG. 10 shows a method 1000 that may be performed by an electronic lock management application of a wireless-communication device for controlling an electronic lock device according to an embodiment of the present disclosure. The method 1000 may be performed to control operation of an electronic lock device that is operating in a standalone mode. The standalone electronic lock device need not be associated with an enterprise or managed by a centralized electronic lock management service. For example, the method 1000 may be performed by the electronic lock management application 210 executable by the Bluetooth®-communication device 202 shown in FIG. 2. At 1001, the method 1000 may include joining a secure wireless connection with an electronic lock device. In one example, joining may include, at 1002, sending to an electronic lock device via a wireless-communication network a binding code. It will be appreciated that the binding code may be automatically sent by the wireless-communication device without involvement by the electronic lock management application.

At 1004, the method 1000 may include receiving from the electronic lock device via the local wireless-communication network a response inquiring about the presence of an electronic lock management application on the wireless-communication device.

At 1006, the method 1000 may include sending to the electronic lock device via the local wireless-communication network a request to unlock a lock mechanism of the electronic lock device. The request may provide an indication that the electronic lock management application is present on the wireless-communication device. The request may further include a security code

At 1008, the method 1000 may include receiving from the electronic lock device via the local wireless-communication network a response indicating that the request is accepted. The request may be accepted responsive to validation of the security code by the electronic lock device. The response may further indicate that the lock mechanism has been successfully unlocked.

At 1010, the method 1000 may include sending to the electronic lock device via the local wireless-communication network a request for operating information of the electronic lock device. The operating information may include one or more of history data, permissions, binding codes, security codes, constraints associated with security codes, and other information related to operation of the electronic lock device.

At 1012, the method 1000 may include receiving from the electronic lock device via the local wireless-communication network operating information of the electronic lock device.

At 1014, the method 1000 may include displaying the operating information of the electronic lock device.

At 1016, the method 1000 may include sending to the electronic lock device via the local wireless-communication network a command to associate a constraint with a binding code or a security code of the electronic lock device. In some cases, associating may include add a new constraint to a binding code or a security code. In some cases, associating may include modifying an existing constraint associated with a binding code or a security code.

At 1018, the method 1000 may include sending to the electronic lock device via the local wireless-communication network a command to associate a permission of a wireless-communication device with the electronic lock device. A permission may allow a wireless-communication device to establish a secure wireless connection with the electronic lock device and control operation of the electronic lock device In some cases, associating may include adding a new permission. In some cases, associating may include modifying an existing permission.

At 1020, the method 1000 may include displaying an updated list of wireless-communication devices that currently have permission to control the electronic lock device.

The above method may enable a wireless-communication device that has an electronic lock application to control operation of an electronic lock device via a local wireless-communication network.

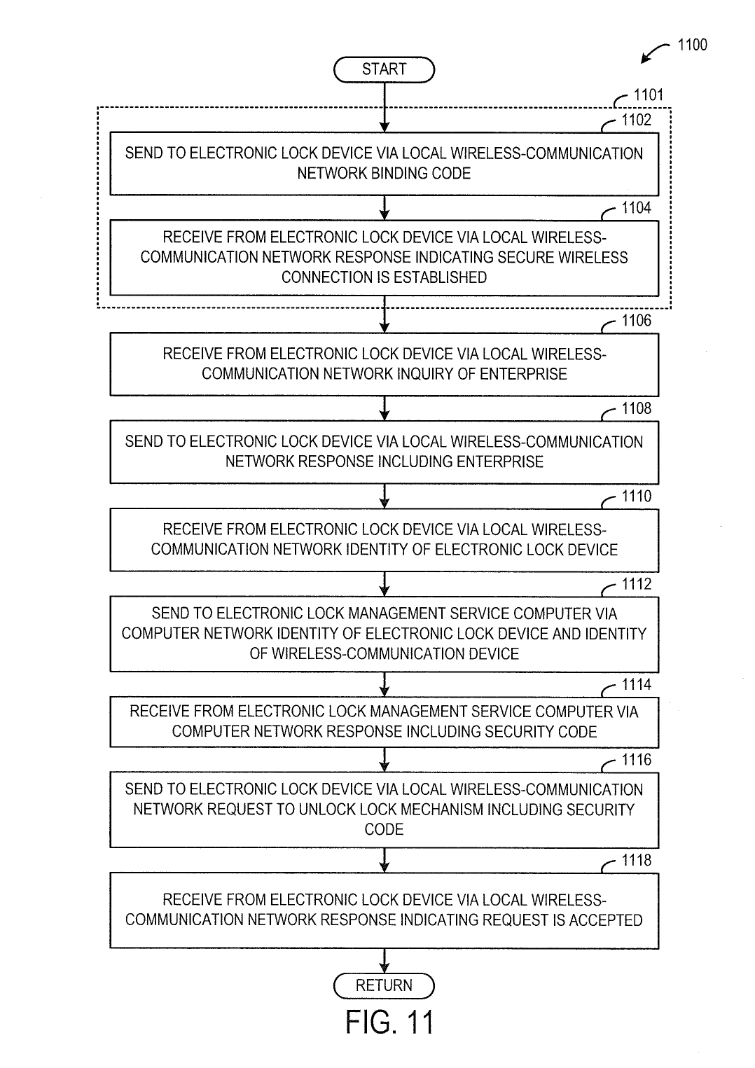

FIG. 11 shows a method 1100 that may be performed by an electronic lock management application of a wireless-communication device for establishing a secure wireless connection with an electronic lock device in an electronic lock system according to an embodiment of the present disclosure. The method 1100 may be performed to control operation of an electronic lock device that is operating in a system mode. The electronic lock device may be associated with an enterprise and managed by a centralized electronic lock management service. For example, the method 1100 may be performed by the electronic lock management application 512 shown in FIG. 5. At 1001, the method 1100 may include joining a secure wireless connection with an electronic lock device. In one example, joining may include, at 1102, sending to an electronic lock device via a wireless-communication network a binding code. It will be appreciated that the binding code may be automatically sent by the wireless-communication device without involvement by the electronic lock management application.

At 1104, the method 1100 may include receiving from the electronic lock device via the local wireless-communication network a response indicating that a secure wireless connection is established between the wireless-communication device and the electronic lock device. The secure wireless connection may be joined responsive to validation of the binding code by the electronic lock device.

At 1106, the method 1100 may include receiving from the electronic lock device via the local wireless-communication network an inquiry of the enterprise or system associated with the electronic lock management application.

At 1108, the method 1100 may include sending to the electronic lock device via the local wireless-communication network a response to the inquiry that includes the associated enterprise or system.

At 1110, the method 1100 may include receiving from the electronic lock device via the local wireless-communication network an identity of the electronic lock device. For example, the identity may include a unique or individualized serial number or other suitable identifying information. The electronic lock device may check whether the electronic lock device and the electronic lock management application are part of the same enterprise. If the electronic lock device and the electronic lock management application are part of the same enterprise, then the electronic lock device may send the identity to the electronic lock management application.

At 1112, the method 1100 may include sending to a centralized electronic lock management service computer via a computer network the identity of the electronic lock device and an identity of the wireless-communication device (e.g., the device performing the method). The computer network may differ from the local wireless-communication network. For example, the local wireless-communication network may include a Bluetooth® network and the computer network may include a wireless LAN.

At 1114, the method 1100 may include receiving from the centralized electronic lock management service computer via a computer network a security code. The security code may be associated with the electronic lock device, and in some cases unique or individualized to the electronic lock device. The security code may be sent by the centralized electronic lock management service computer responsive to validation of the wireless-communication device.

At 1116, the method 1100 may include sending to the electronic lock device via the wireless-communication network a request to unlock a lock mechanism of the electronic lock device including the security code.

At 1118, the method 1100 may include receiving from the electronic lock device via the wireless-communication network a response indicating the request is accepted. The request may be accepted responsive to validation of the security code by the electronic lock device. The response may further indicate that the lock mechanism has been successfully unlocked.

The method enables an electronic lock management application on a wireless-communication device to control different electronic lock devices in an electronic lock system that is centrally managed.

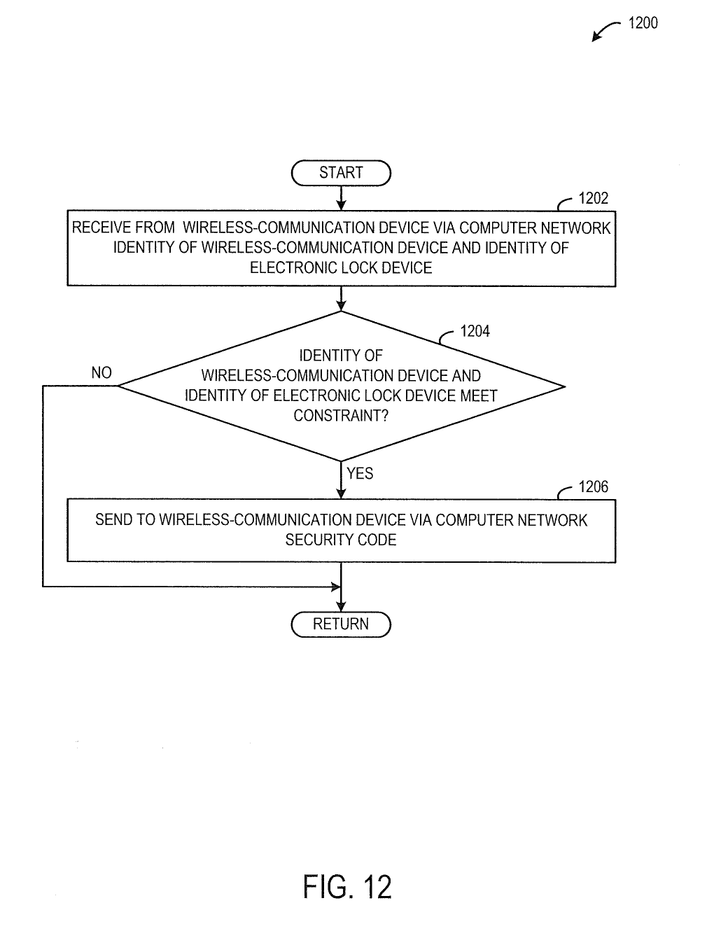

FIG. 12 shows a method 1200 that may be performed by an electronic lock management service computer for granting permission for a wireless-communication device to control an electronic lock device. For example, the method 1200 may be performed by the centralized electronic lock management service computer 506 shown in FIG. 5. At 1202, the method 1200 may include receiving from a wireless-communication device via a computer network an identity of the wireless-communication device and an identity of an electronic lock device.

At 1204, the method 1200 may include determining whether the identity of the electronic lock device and the identity of the wireless-communication device meet a constraint. The constraint may include any suitable constraint designated by the centralized electronic lock management service. For example, the constraint may include the wireless-communication device being on an approved list of devices having permission to control the electronic lock device. If the identity of the electronic lock device and the identity of the wireless-communication device meet the constraint, then the method 1200 moves to 1206. Otherwise, the method 1200 returns to other operations.

At 1206, the method 1200 may include sending to the wireless-communication device via the computer network a security code. The security code may be sent from an electronic lock management application of the wireless-communication device to the electronic lock device via a local wireless-communication network to control operation of the electronic lock device.

It will be appreciated that the above method may be performed repeatedly to grant permission to a plurality of different wireless-communication devices to control a plurality of electronic lock devices in what collectively may be referred to as an electronic lock system.

Furthermore, it will be understood that some of the method steps described and/or illustrated herein may in some embodiments be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used. Furthermore, one or more of the illustrated actions, functions, or operations of the above described methods may be combined with operations from another method according to a particular strategy.

While the above disclosure provides Bluetooth® as a nonlimiting example of a wireless communication mechanism that can be used with an electronic lock device, it is to be understood that other wireless communication mechanisms are also within the scope of this disclosure. In practice, any wireless communication mechanism that allows the lock to identify and verify a candidate wireless-key may be used. Further while the above disclosure provides a mobile phone as a nonlimiting example of a wireless-communication device that can be used to wirelessly communicate with an electronic lock device, it is to be understood that other wireless-communication devices are also within the scope of the present disclosure. Non-limiting examples of wireless-communication devices that may be used to control an electronic lock device include a mobile phone, a smartphone, a wireless-enabled media player, a wireless-enabled portable game console, a wireless-enabled home gaming console, a wireless-enabled tablet computing device, a wireless-enabled notebook computing device, a wireless-enabled desktop computing device, a wireless-enabled server computing device, a wireless-enabled motor vehicle computing device, etc.

It is to be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. An electronic lock device comprising:
a lock mechanism configured to switch between a locked state and an unlocked state;
a logic machine; and
a storage machine holding instructions executable by the logic machine to:
grant a first wireless-communication device permission to join a secure wireless connection with the electronic lock via a local wireless-communication network;
if the first wireless-communication device includes an electronic lock management application, switch the state of the lock mechanism to the unlocked state in response to joining the secure wireless connection with the first wireless-communication device and receiving a valid security code from the electronic lock management application; and
if the first wireless-communication device does not include the electronic lock management application, automatically switch the state of the lock mechanism to the unlocked state in response to joining the secure wireless connection with the first wireless-communication device.

2. The electronic lock device of claim 1, wherein the local wireless-communication network is a Bluetooth® network, and the wireless-communication device is a Bluetooth®-enabled mobile phone.

3. The electronic lock device of claim 1, wherein the electronic lock device is initialized with an individualized binding code, and wherein granting the first wireless-communication device permission includes determining that a binding code received from the first wireless-communication device matches the individualized binding code of the electronic lock device.

4. The electronic lock device of claim 1, wherein the state of the lock mechanism switches to the unlocked state only if a number of unlock events initiated by the first wireless-communication device is fewer than a threshold number of unlock events.

5. The electronic lock device of claim 1, wherein the state of the lock mechanism switches to the unlocked state only if a number of wireless-communication devices currently bound with the electronic lock device using a designated binding code is less than a threshold number of wireless-communication devices that can use the designated binding code.

6. The electronic lock device of claim 1, wherein the state of the lock mechanism switches to the unlocked state only if one or more of a current time is within a designated time period, or the electronic lock device is currently positioned within a threshold distance of a designated location.

7. The electronic lock device of claim 1, wherein the storage machine further holds instructions executable by the logic machine to:
grant a second wireless-communication device permission to join a secure wireless connection with the electronic lock via the local wireless-communication network;
if the second wireless-communication device includes an electronic lock management application, switch the state of the lock mechanism to the unlocked state in response to joining the secure wireless connection with the second wireless-communication device and receiving a valid security code from the electronic lock management application; and
if the second wireless-communication device does not include the electronic lock management application, automatically switch the state of the lock mechanism to the unlocked state in response to joining the secure wireless connection with the second wireless-communication device.

8. The electronic lock device of claim 7, wherein the electronic lock device includes a first individualized binding code, and wherein granting the second wireless-communication device permission includes determining that a binding code received from the second wireless-communication device matches the first individualized binding code of the electronic lock device.

9. The electronic lock device of claim 8, wherein the electronic lock device includes a second individualized binding code that is different from the first individualized binding code, and wherein granting the first wireless-communication device permission includes determining that a binding code received from the first wireless-communication device matches the second individualized binding code of the electronic lock device.

10. The electronic lock device of claim 8, wherein granting the first wireless-communication device permission includes determining that a binding code received from the first wireless-communication device matches the first individualized binding code of the electronic lock device.

11. A method for controlling a first electronic lock device with an electronic lock management application of a wireless-communication device, the method comprising:
joining a secure wireless connection with the first electronic lock device via a local wireless-communication network;
sending to the first electronic lock device via the local wireless-communication network a request to unlock a lock mechanism of the first electronic lock device, the request including a first security code; and
receiving from the first electronic lock device via the local wireless-communication network a response indicating the request is accepted in response to joining the secure wireless connection and the first security code being valid.

12. The method of claim 11, further comprising:
receiving from the first electronic lock device via the local wireless-communication network an identity of the first electronic lock device if the electronic lock management application and the electronic lock device are associated with a same enterprise;
sending to an electronic lock management service computer via a computer network the identity of the first electronic lock device and an identity of a wireless-communication device; and
receiving from the electronic lock management service computer via the computer network a response including the first security code if the identity of the first electronic lock device and the identity of the wireless-communication device are valid.

13. The method of claim 11, further comprising:
joining a secure wireless connection with a second electronic lock device via the local wireless-communication network;
sending to the second electronic lock device via the local wireless-communication network a request to unlock the lock mechanism of the second electronic lock device, the request including a second security code; and
receiving from the second electronic lock device via the local wireless-communication network a response indicating the request is accepted in response to joining the secure wireless connection and the second security code being valid.

14. The method of claim 11, further comprising:
receiving from the first electronic lock device via the local wireless-communication network operating information of the first electronic lock device; and
displaying operating information of the first electronic lock device including a list of wireless-communication devices that have unlocked or locked the lock mechanism of the first electronic lock device and corresponding times when the wireless-communication devices unlocked or locked the lock mechanism of the first electronic lock device.

15. The method of claim 11, further comprising:
sending to the first electronic lock device via the local wireless-communication network a command to associate a constraint with a binding code or a security code of the first electronic lock device.

16. The method of claim 11, further comprising:
receiving from the first electronic lock device via the local wireless-communication operating information of the first electronic lock device; and
displaying a list of wireless-communication devices that currently have permission to control the first electronic lock device based on the operating information.

17. The method of claim 16, further comprising:
sending to the first electronic lock device via the local wireless-communication network a command to modify a permission of a wireless-communication device to unlock the lock mechanism of the first electronic lock device; and
displaying an updated list of wireless-communication devices that currently have permission to control the first electronic lock responsive to sending the command.

18. An electronic lock management service computer comprising:
a logic machine; and
a storage machine holding instructions executable by the logic machine to:
receive from a wireless-communication device via a computer network an identity of the wireless-communication device and an identity of an electronic lock device; and
if the identity of the electronic lock device and the identity of the wireless-communication device meet a constraint, send to the wireless-communication device via the computer network a security code, the security code being sent from the wireless-communication device to the electronic lock device via a local wireless-communication network to grant permission to the wireless-communication device to unlock a lock mechanism of the electronic lock device.

19. The electronic lock management service computer of claim 18, wherein the constraint includes the wireless-communication device being on a list of devices having permission to control the electronic lock device, the list being maintained by the electronic lock management service computer.

20. The electronic lock management service computer of claim 18, wherein the security code is not valid for consecutive unlock events between the wireless-communication device and the electronic lock device.
